(19) United States
(12) Patent Application Publication
(10) Pub. No.: US 2025/0086689 A1
(43) Pub. Date: Mar. 13, 2025

(54) EXTRACTION SYSTEM, EXTRACTION METHOD, AND RECORDING MEDIUM

(71) Applicant: NEC Corporation, Tokyo (JP)

(72) Inventors: Akihito KATAOKA, Tokyo (JP); Yudai YAMAGUCHI, Tokyo (JP); Riki ETO, Tokyo (JP); Natsumi USUI, Tokyo (JP)

(73) Assignee: NEC Corporation, Tokyo (JP)

(21) Appl. No.: 18/814,761

(22) Filed: Aug. 26, 2024

(30) Foreign Application Priority Data
Sep. 7, 2023 (JP) 2023-145167

(51) Int. Cl. G06Q 30/0601; G06V 10/40; G06V 10/74; G06V 10/94

(52) U.S. Cl. CPC G06Q 30/0631; G06V 10/40; G06V 10/761; G06V 10/945

(57) ABSTRACT

An extraction system includes an output unit, an acquisition unit, and an update unit. The output unit outputs a feature amount used for similarity determination by an extraction model that extracts a product similar to a target product, a set value of an importance level of the feature amount, and a change field for changing the set value of the importance level of the feature amount. The acquisition unit acquires a change value for changing the set value of the importance level of the feature amount input in the change field of the output screen. The update unit updates the set value of the importance level of the feature amount in the extraction model based on the change value. The extraction system can be used, for example, to support decision making.

This application is based upon and claims the benefit of priority from Japanese Patent Application No. 2023-145167, filed on Sep. 7, 2023, the disclosure of which is incorporated herein in its entirety by reference.

### TECHNICAL FIELD

The present disclosure relates to a data management device and the like.

### BACKGROUND ART

At the planning stage of a new product, for example, demand prediction of the new product is performed. For example, a computer for sales volume prediction of PTL 1 (Japanese Patent Application Laid-Open No. 2022-120816) extracts a product having similar features to those of a new product. Then, the computer for sales volume prediction of PTL 1 predicts the sales volume of a new product based on the sales volume of a similar product.

### SUMMARY

An object of the present disclosure is to provide an extraction system and the like that can facilitate extraction of a product similar to a target product.

An extraction system according to an aspect of the present disclosure includes an output unit for outputting a screen displaying a feature amount used for similarity determination by an extraction model that extracts a product similar to a target product, a set value of an importance level of the feature amount, and a change field for changing the set value of the importance level of the feature amount, an acquisition unit for acquiring a change value for changing the set value of the importance level of the feature amount input to the change field of the output screen, and an update unit for updating a set value of an importance level of the feature amount in the extraction model based on the change value.

An extraction method according to an aspect of the present disclosure includes outputting a screen displaying a feature amount used for similarity determination by an extraction model that extracts a product similar to a target product, a set value of an importance level of the feature amount, and a change field for changing the set value of the importance level of the feature amount, acquiring a change value for changing the set value of the importance level of the feature amount input to the change field of the output screen, and updating a set value of an importance level of the feature amount in the extraction model based on the change value.

A recording medium according to one aspect of the present disclosure non-transiently records an extraction program for causing a computer to execute a process of outputting a screen displaying a feature amount used for similarity determination by an extraction model that extracts a product similar to a target product, a set value of an importance level of the feature amount, and a change field for changing the set value of the importance level of the feature amount, a process of acquiring a change value for changing the set value of the importance level of the feature amount input to the change field of the output screen, and a process of updating a set value of an importance level of the feature amount in the extraction model based on the change value.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of an information processing system according to the present disclosure;

FIG. 2 is a diagram illustrating an example of a display screen in the present disclosure;

FIG. 3 is a diagram illustrating an example of a display screen in the present disclosure;

FIG. 4 is a diagram illustrating an example of a configuration of an extraction system in the present disclosure;

FIG. 5 is a diagram illustrating an example of a display screen in the present disclosure;

FIG. 6 is a diagram illustrating an example of a display screen in the present disclosure;

FIG. 7 is a diagram illustrating an example of a display screen in the present disclosure;

FIG. 8 is a diagram illustrating an example of an operation flow of the extraction system in the present disclosure;

FIG. 9 is a diagram illustrating an example of an operation flow of the extraction system in the present disclosure;

FIG. 10 is a diagram illustrating an example of an operation flow of the extraction system in the present disclosure; and

FIG. 11 is a diagram illustrating an example of a hardware configuration in the present disclosure.

### EXAMPLE EMBODIMENT

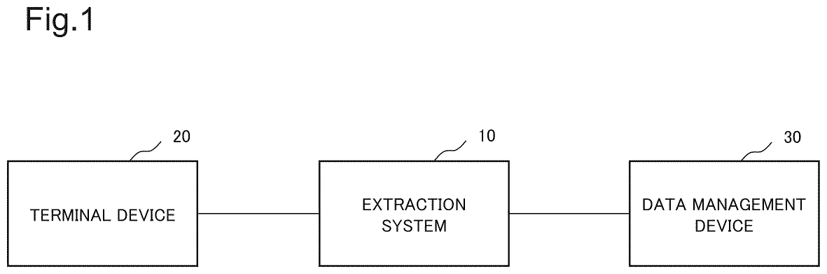

Example embodiments of the present disclosure will be described in detail with reference to the drawings. FIG. 1 is a diagram illustrating an example of a configuration of an information processing system. The information processing system includes, for example, an extraction system 10, a terminal device 20, and a data management device 30. The extraction system 10 is connected to the terminal device 20 via, for example, a network. The extraction system 10 is connected to the data management device 30 via, for example, a network. A plurality of terminal devices 20 and a plurality of data management devices 30 may be provided.

The information processing system is, for example, a system that extracts a product similar to a target product using an extraction model. The extraction model is, for example, a learning model that extracts a product similar to the target product with attribute data of the target product as an input. The product may include items and services. In addition, the product may include agricultural and marine products. The product is not limited to the above.

The target product is, for example, a product for which the user wishes to obtain information on a product similar to the target product. The product similar to the target product is, for example, a product to be compared with the target product. The product similar to the target product is, for example, a product to be referred to when considering commercialization of the target product. For example, when predicting the sales quantity of a new product, demand prediction of the new product is performed using data of the sales quantity of a product similar to the new product. In this case, the target product is a new product. The product similar to the new product is, for example, a product similar in features to the new product. For example, there is a high possibility that the sales quantity of the new product shows a tendency similar to the result of the sales quantity of the product similar in features to the new product. Therefore, information on a product similar in features to the new product can be used, for example, to predict the sales quantity of the new product. The product similar to the target product may be a product that competes with the target product due to similarity in features when the target product is sold in the market.

The product similar to the target product is, for example, a product having similar attribute data as the target product. The attribute is, for example, data representing features of a product. The attribute is data representing features of a product by using a separation or a numerical value. The attribute data is, for example, data related to an attribute that can affect the application of the extraction result by the extraction model among the attributes of the product. For example, when the application of the extraction result is the prediction of the sales quantity, the attribute data is data that may affect the prediction of the sales quantity. The attribute data is, for example, one or a plurality of items of a design, a price, a target customer class, a season to be sold in, a sales quantity, a sales region, a distribution route, a sales form, a designer, a manufacturer, a seller, a brand, and a production area. The attribute data is not limited to the above. Furthermore, the target product is not limited to a new product. For example, the target product is a product at a planning stage, a product at a concept stage, or a product for market research. The target product may be a product already on the market.

Extraction of products similar to the target product can be performed, for example, in products of clothing, shoes, bags, watches, decorations, electrical appliances, electronics, automobiles, bicycles, sporting goods, beverages, foods, furniture, utensils, or houses. The type of product to be extracted is not limited to the above.

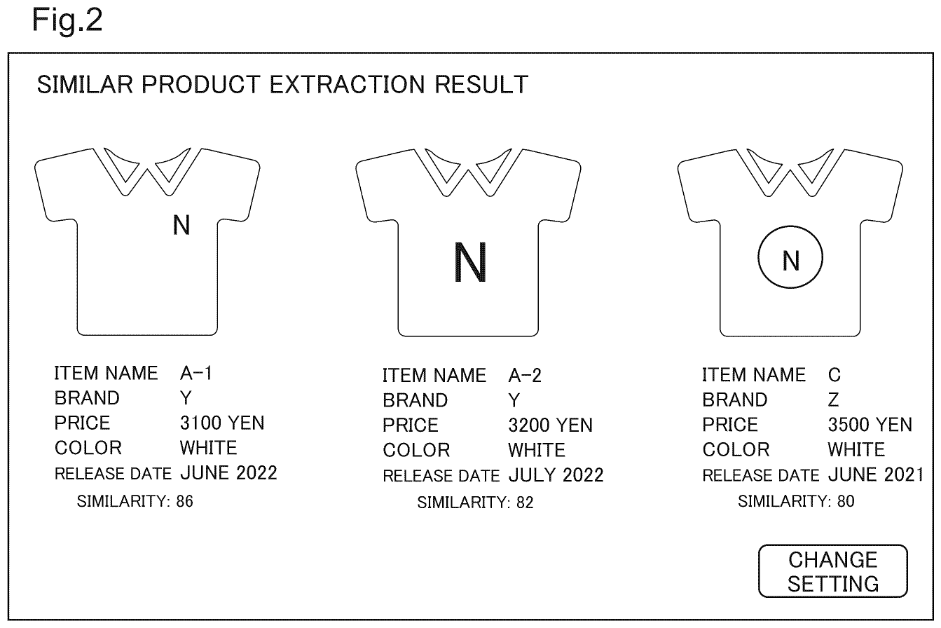

FIG. 2 is an example of a display screen displaying a result of extracting a product similar to the target product. In the example of the display screen of FIG. 2, three products similar to the target product are displayed. In the example of the display screen of FIG. 2, data of an attribute indicating features of a product is displayed for each product. For example, the user can confirm a product similar to the target product and confirm the validity of a result of the extraction by referring to the screen shown in the example of the display screen of FIG. 2. Details of FIG. 2 will be described later.

When an extraction result of a product similar to the target product is used for demand prediction of the product, the demand prediction of the product is, for example, prediction of a demand of the product. The demand is, for example, a sales quantity or sales of a product. The demand is not limited to the above. The demand prediction is performed, for example, using a demand prediction model based on attribute data of a product. The demand prediction model is generated, for example, by learning a relationship between attribute data of a product and a demand of the product. Data of a product similar to the target product is used, for example, for training data of the demand prediction model. Data of a product similar to the target product is used, for example, for verification of a result of demand prediction by a demand prediction model. For example, the validity of the result of the demand prediction can be verified by comparing the attribute data of the product similar to the target product and the demand of the product similar to the target product with the attribute data of the target product and the demand of the target product predicted by the demand prediction model.

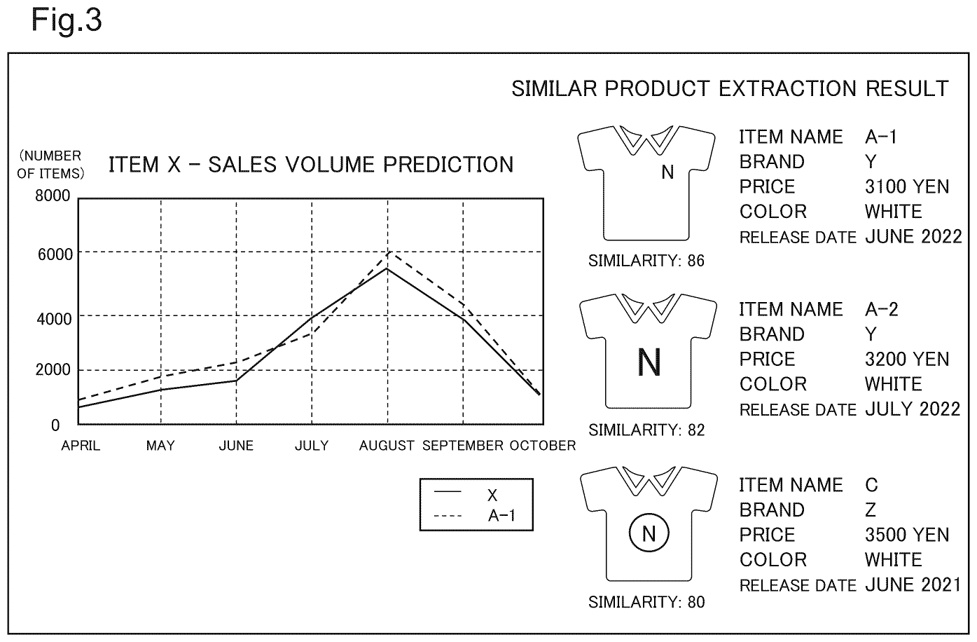

FIG. 3 illustrates an example of a display screen in a case where an extraction result of a product similar to the target product is used in the demand prediction system of a product. The example of the display screen of FIG. 3 is an example of a screen displaying a prediction result of the sales quantity of the item X as a result of the demand prediction of the product. In the example of the display screen of FIG. 3, a graph showing a predicted value of the sales quantity of the item X and a sales result of the item A-1 is displayed. The sales result of the item A-1 is the sales data of the monthly sales quantity in the past. In the example of the display screen of FIG. 3, an extraction result of an item similar to the target product is displayed. In the example of the display screen of FIG. 3, for example, information of items similar to those in the example of the display screen of FIG. 2 is displayed as an extraction result of the product similar to the target product. In the example of the display screen of FIG. 3, data of sales results of the item similar to the target product is displayed in the graph by clicking an image of an item similar to the target product.

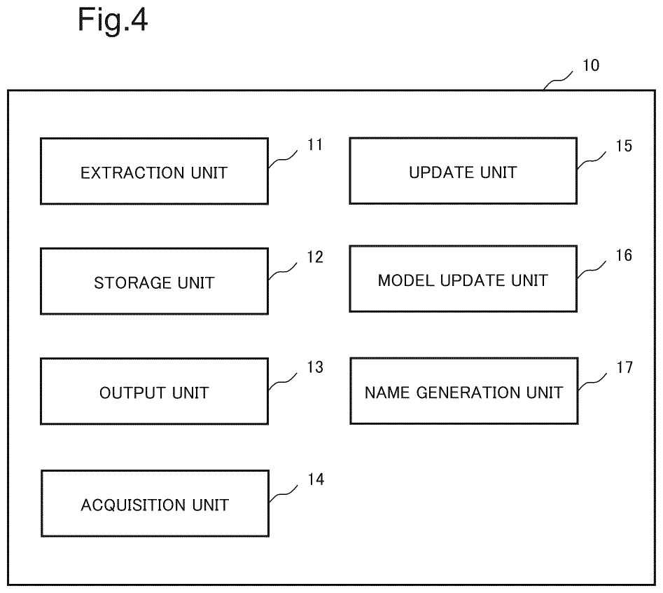

Here, a specific example of the configuration of the extraction system 10 will be described. FIG. 4 is a diagram illustrating an example of a configuration of the extraction system 10. The extraction system 10 includes an output unit 13, an acquisition unit 14, and an update unit 15 as a basic configuration. The extraction system 10 includes, for example, an extraction unit 11, a model update unit 16, a name generation unit 17, and a storage unit 12.

The extraction unit 11 extracts a product similar to the target product, for example, using the extraction model. The extraction model is, for example, a learning model for extracting a product similar to the target product. A method of generating the extraction model will be described later. For example, the extraction model outputs a product similar to the target product as an extraction result with information on the target product as an input of the extraction model. For example, the extraction unit 11 extracts a product similar to the target product from the data saved in the data management device 30. When a plurality of extraction models is generated, the extraction unit 11 extracts a product similar to the target product using the extraction model selected on the screen output by the output unit 13. Furthermore, when the set value of the importance level of the feature amount is changed, the extraction unit 11 extracts a product similar to the target product using the extraction model based on the changed set value. Furthermore, in a case where the extraction model is a learning model capable of estimating the reason for the extraction result, the extraction unit 11 may generate the reason for the extraction result based on the output of the extraction model.

The extraction unit 11 extracts, for example, a product having similarity equal to or more than a reference as a product similar to the target product. The reference of similarity to extract as a similar product is set based on a value at which the product can be regarded as being similar to the target product when the similarity of the product is equal to or more than a reference value. The similarity is, for example, an index indicating the extent at which the extracted product is similar to the target product. The similarity is, for example, accuracy of classification by the extraction model. The extraction unit 11 may extract products having similarity from a high rank to a predetermined rank as products similar to the target product. The predetermined rank is set to be an appropriate number for the user to refer to the extracted product.

Extraction of a product similar to the target product may be performed by using any extraction model among the plurality of extraction models that have been generated. When a plurality of extraction models is generated, the extraction unit 11 extracts a product similar to the target product using, for example, the extraction model selected by the user. Furthermore, the extraction unit 11 may extract a product similar to the target product using an extraction model based on the type of the target product. The extraction unit 11 may extract a product similar to the target product using an extraction model based on the user among the plurality of extraction models. In a case where the user is a person in the food industry, the extraction unit 11 may extract a product similar to the target product using an extraction model generated for the food industry. For example, the extraction unit 11 may extract a product similar to the target product using the extraction model according to the affiliation of the user based on the login information of the user. In this case, the relationship between the affiliation of the user and the extraction model is set as, for example, a table indicating the relationship between the affiliation of the user and the extraction model.

The storage unit 12 saves, for example, data related to a process of extracting a product similar to the target product. The storage unit 12 saves, for example, the extraction model. The storage unit 12 saves, for example, a set value of the importance level of the feature amount in the extraction model. The storage unit 12 saves, for example, the weight of the feature amount in the extraction model. The storage unit 12 may save a change history of the set value when the set value of the importance level of the feature amount is changed. The storage unit 12 saves, for example, a name generation model. The storage unit 12 saves, for example, an extraction result of a product similar to the target product by the extraction model. In addition, the storage unit 12 saves training data used for training and re-training of the extraction model.

The output unit 13 outputs a screen displaying the feature amount used by the extraction model for similarity determination, the set value of the importance level of the feature amount, and a change field for changing the set value of the importance level of the feature amount. The extraction model is a learning model for extracting a product similar to the target product. The output unit 13 outputs, for example, the feature amount in the extraction model saved in the storage unit 12 and the set value of the importance level of the feature amount. For example, the output unit 13 outputs, to the terminal device 20, a screen displaying the feature amount used for similarity determination by the extraction model that extracts a product similar to the target product, the set value of the importance level of the feature amount, and the change field for changing the set value of the importance level of the feature amount. For example, the output unit 13 may output, to a display device (not illustrated) connected to the extraction system 10, a screen displaying the feature amount used for similarity determination by the extraction model that extracts a product similar to the target product, the set value of the importance level of the feature amount, and the change field for changing the set value of the importance level of the feature amount.

The feature amount is, for example, a variable related to features of a product and is a variable used by the extraction model for similarity determination. The weight of the feature amount is, for example, a weight for each feature amount used by the extraction model for similarity determination. The importance level of the feature amount is an index obtained by converting the weight of the feature amount in the extraction model in such a way as to be an index easy for the user to understand. The importance level of the feature amount is, for example, a value obtained by normalizing the weight of each feature amount used by the extraction model for similarity determination. For example, the user can easily change the set value related to the weight of the feature amount by normalizing the weight of the feature amount. The importance level of the feature amount may be a coefficient by which the weight of each feature amount used by the extraction model for similarity determination is multiplied. The importance level of the feature amount is not limited to the above. In a case where the importance level of the feature amount is a value obtained by normalizing the weight of the feature amount, the importance level of the feature amount is calculated, for example, by normalizing the weight of each feature amount using the value of the weight of a predetermined feature amount. The predetermined feature amount is, for example, a feature amount assumed to be important in performing similarity determination. The predetermined feature amount may be a feature amount having the largest weight value. The predetermined feature amount is not limited to the above.

In a case where a change value for changing the set value of the importance level of the feature amount is input by the operation of the user to the change field of the output screen, the output unit 13 outputs, for example, a screen displaying the set value of the importance level of the feature amount after the change. The change value for changing the set value of the importance level of the feature amount is acquired by the acquisition unit 14 from, for example, the terminal device 20. In a case where a change value for changing the set value of the importance level of the feature amount is input by the operation of the user to the change field of the output screen, the output unit 13 may output a screen displaying the set value of the importance level of the feature amount before and after the change.

The output unit 13 may output a screen displaying the set value of the importance level of the feature amount using a predetermined numerical value indicating a standard value when the set value of the importance level of the feature amount has not been changed from the set value in the extraction model. For example, in a case where a predetermined numerical value indicating a standard value is set as 3, the output unit 13 outputs the importance level of the feature amount not changed from the set value in the extraction model as 3. The predetermined numerical value is set such that the set value of the degree of importance level of the feature amount can be increased or decreased. When a change value for changing the set value of the importance level of the feature amount is input by the operation of the user to the change field of the output screen, the output unit 13 outputs a screen displaying the set value of the importance level of the feature amount using the input change value. The change value for changing the set value of the importance level of the feature amount is acquired by the acquisition unit 14 from, for example, the terminal device 20.

For example, when outputting a screen displaying the product extracted by an extraction model, the output unit 13 outputs a screen that further displays the feature amount that has contributed to the similarity determination on similarity with the target product. The feature amount that has contributed to the similarity determination on similarity with the target product may be displayed on the same screen as the screen displaying the product extracted by the extraction model. The user can recognize the degree of influence of the feature amount on the similarity determination by referring to the feature amount that has contributed to the similarity determination on similarity with the target product. For example, when a product similar to the target product is extracted for use in the demand prediction of the product, the user can determine whether the extracted product is appropriate as a product similar to the target product by referring to the feature amount that has contributed to the similarity determination on similarity with the target product. For example, the user can more appropriately set the importance level of the feature amount by referring to the feature amount that has contributed to the similarity determination on similarity with the target product and changing the set value of the importance level of the feature amount.

The output unit 13 outputs, for example, a screen displaying the feature amount that has contributed most to the similarity determination on similarity with the target product. The output unit 13 outputs, for example, a screen displaying the feature amount that has contributed to the similarity determination by the extraction model in descending order of contribution to the similarity determination. The output unit 13 outputs, for example, a screen displaying feature amounts having a contribution degree to the similarity determination on similarity with the target product from a high rank to a predetermined rank. The output unit 13 may output a screen displaying a feature amount whose contribution degree to the similarity determination on similarity with the target product is equal to or more than a predetermined reference. The predetermined rank and the predetermined reference are set such that, for example, the number of output feature amounts is an appropriate number for the user to refer to the displayed feature amounts. In a case where the extraction model is a learning model capable of estimating the reason for the extraction result, the output unit 13 may output a screen displaying the reason for extraction together with the product extracted by the extraction model.

When displaying a plurality of products similar to the target product, the output unit 13 may output a screen on which the product displayed within the screen among the plurality of products can be changed by scrolling the screen. Furthermore, when displaying a plurality of products similar to the target product, the output unit 13 may output a screen displaying a button that enables the displayed product to be changed by switching pages. A mode for displaying a plurality of products similar to the plurality of target products can be appropriately set.

The output unit 13 may output, for example, a screen for selecting a product to be used as training data from candidates of a product to be used as training data of the extraction model. The output unit 13 outputs, for example, a screen displaying the product extracted by the extraction model as a candidate for training data. The output unit 13 may output a screen that further displays the feature amount used by the extraction model to extract the product as a candidate for the training data. The output unit 13 outputs, for example, a feature amount having a weight value equal to or more than a reference among feature amounts used by the extraction model to extract a product. The reference of the weight value is set based on, for example, a value that can be regarded as contributing to similarity determination performed by the extraction model. For example, the output unit 13 may further output a screen displaying the product extracted by the extraction model and the feature amount used by the extraction model to extract the product as candidates of the training data.

The output unit 13 outputs, for example, a screen for selecting a product to be used as training data among the products extracted by the extraction model on the screen. That is, the output unit 13 outputs, for example, a screen for selecting a product to be used for relearning of the extraction model on the screen. The output unit 13 outputs, for example, a screen displaying the product extracted by the extraction model and a check box to be checked when selecting to use the product as the training data. The output unit 13 outputs, for example, a screen on which whether the feature amount used by the extraction model to extract the product is to be used as the training data can be selected. The output unit 13 outputs, for example, a screen displaying the feature amount used by the extraction model to extract the product and a check box to be checked when selecting to use the feature amount as the training data.

In a case where the extraction model selected by the user among the plurality of extraction models is used for extraction of a product similar to the target product, the output unit 13 outputs, for example, a screen for selecting one of the extraction models from the plurality of extraction models. Then, the output unit 13 outputs a screen displaying the feature amount in the selected extraction model, the set value of the importance level of the feature amount, and a change field for changing the set value of the importance level of the feature amount. The output unit 13 outputs, for example, a screen displaying a pull-down menu from which an extraction model can be selected from the plurality of extraction models.

The output unit 13 outputs, for example, a button for increasing or decreasing the set value by operating on the screen as a change field for changing the set value of the importance level of the feature amount. The output unit 13 outputs an image for increasing or decreasing the set value by, for example, operating the “+” button and the “−” button on the screen. The button may include a slide bar. The output unit 13 outputs, for example, a slide bar for increasing or decreasing the set value by being operated. The change field for changing the set value of the importance level of the feature amount is not limited to the above.

The output unit 13 may output a screen displaying a button that can transition between the display screen of the extraction result and the change screen of the set value. The output unit 13 may output a screen displaying a button that can transition between the display screen of the extraction result and the screen for selecting the training data of the extraction model. The output unit 13 outputs, for example, a screen including a button for switching between a screen for displaying the product extracted by the extraction model and a screen for displaying a change field for changing the set value of the importance level of the feature amount in the extraction model. When the button is pressed on the screen, the output unit 13 outputs the screen associated with the pressed button.

The output unit 13 outputs, for example, a screen that further displays a standard feature amount in an industry in which the target products are distributed. The output unit 13 outputs, for example, a screen displaying a feature amount frequently used for extraction of similar products in an industry in which target products are distributed. For example, in a case where the color and the price of the package have a large influence on the sales quantity in the industry in which the target products are distributed, the output unit 13 outputs a screen showing that the color and the price are important items. The standard feature amount in the industry in which the target products are distributed is set as, for example, a table indicating a relationship between the type of product and the feature amount.

Each of the screens described above may be generated in the terminal device 20. In a case where the image data of the screen is generated in the terminal device 20, the output unit 13 outputs an instruction of the display content to the terminal device 20.

The acquisition unit 14 acquires the change value of the importance level of the feature amount input on the screen. For example, the acquisition unit 14 acquires, from the terminal device 20, a change value of the importance level of the feature amount input by the user's operation.

The acquisition unit 14 acquires, for example, a selection result of a product to be used as training data, which is input by an operation of selecting a product from a plurality of products displayed on the screen. The acquisition unit 14 acquires, for example, selection of a feature amount to be used as training data selected on the screen. The acquisition unit 14 may acquire the product to be used as the training data and the selection of the feature amount selected on the screen.

The acquisition unit 14 acquires, for example, information on the target product. The information on the target product is, for example, information for specifying a target product from which a user wishes to extract a similar product. The information for specifying the target product is, for example, the name of the target product and attribute data of the target product. The information for specifying the target product is not limited to the above.

When a plurality of extraction models is generated, the acquisition unit 14 acquires, for example, selection of an extraction model to be used to extract a product similar to the target product. The acquisition unit 14 acquires, for example, selection of an extraction model to be used for extraction of a product similar to the target product from the terminal device 20. The selection of an extraction model to be used for extraction of a product similar to the target product is input to, for example, the terminal device 20 by a user's operation.

The update unit 15 updates the set value of the importance level of the feature amount in the extraction model based on the change value acquired by the acquisition unit 14. For example, the update unit 15 updates the weight of the feature amount, which is an actual parameter in the extraction model, based on a set value of the importance level of the changed feature amount. For example, when the set value of the importance level of the feature amount is normalized, the update unit 15 calculates the weight of the feature amount from the normalized updated set value and updates the weight of the feature amount in the extraction model.

The update unit 15 may update the set value of the importance level of the feature amount in the extraction model as a temporary value based on the change value acquired by the acquisition unit 14. The update unit 15 may update the set value of the importance level based on the selection of whether to update the set value as a temporary value or a non-temporary value. Updating as a temporary value means that the updated value is not used in a case where similar products are extracted again after similar products are extracted once based on the updated set value. Updating as a non-temporary value means that the updated value is used in a case where similar products are extracted again after similar products are extracted based on the updated set value. The update unit 15 may add an identifier to each change value acquired by the acquisition unit 14, and update such that there is a plurality of set values of the importance level of the feature amount in the extraction model. For example, the update unit 15 may update the set value of the importance level of the feature amount in the extraction model based on the selection of which change value is to use for update among the plurality of change values.

For example, the model update unit 16 generates the extraction model by performing relearning using the selected product or feature amount as training data. Generating the extraction model by relearning is also referred to as updating the extraction model. The model update unit 16 performs relearning using, for example, the same algorithm as the algorithm used for generating the extraction model.

The model update unit 16 generates an extraction model by, for example, reverse reinforcement learning. For example, the model update unit 16 generates an extraction model by performing reverse reinforcement learning with attribute data of a product as an explanatory variable and an extraction result of a similar product as an objective variable. The model update unit 16 may generate the extraction model by reverse reinforcement learning based on factorized asymptotic Bayesian inference. When performing reverse reinforcement learning based on factorized asymptotic Bayesian inference, the model update unit 16 generates a plurality of linear models that are case classified by a rule in a decision tree format, with attribute data of a product as an explanatory variable and an extraction result of a similar product as an objective variable. Then, the model update unit 16 generates the extraction model by sequentially performing process of optimization of a data under case classification condition, generation of a linear model by optimization of a combination of explanatory variables, and deletion of an unnecessary linear model. In the extraction model generated by such a method for generating a learning model by a combination of different explanatory variables, the extraction result can be explained using the condition for case classification having a strong influence on the extraction result of a similar product, and thus the explanatory property of the extraction result is improved. That is, the extraction model is a learning model that can explain the reason why a product is extracted as a product similar to the target product.

The model update unit 16 may generate the extraction model by deep learning using a neural network. The algorithm used for machine learning to generate the extraction model is not limited to the above.

The model update unit 16 saves the updated extraction model in, for example, the storage unit 12. The model update unit 16 may add an identifier to the updated extraction model and save the extraction model after the update separately from the extraction model before the update. For example, the model update unit 16 adds a name different from that before the update to the updated extraction model, and saves the extraction model after the update separately from the extraction model before the update.

When the extraction model is generated in the extraction system 10, the model update unit 16 generates, for example, an extraction model for extracting a product similar to the target product. For example, the model update unit 16 learns a relationship between attribute data of a product and a product selected as a similar product, and generates an extraction model. The extraction model is a learning model for extracting a product similar to the target product from the data of the target product. The extraction model may be generated in a system outside the extraction system 10.

When the extraction model is generated in the extraction system 10, a data acquisition means (not illustrated) may acquire training data of the extraction model. The data acquisition means acquires, for example, a product selected as a product similar to the target product and attribute data of the product as training data of the extraction model. The data acquisition means acquires, for example, a product selected by an expert as a product similar to the target product in the past and attribute data of the product as training data. The data acquisition means acquires, for example, a product selected by an expert of demand prediction as a product similar to a target product of demand prediction and attribute data of the product as training data. The training data acquired by the data acquisition means may be a product selected by the data scientist or the user of the extraction system 10 and attribute data of the product.

For example, when the extraction model is updated, the name generation unit 17 generates the name of the extraction model based on the feature of the training data. For example, when the set value of the importance level of the feature amount is updated, the name generation unit 17 generates the name of the extraction model based on the change value of the set value.

The name generation unit 17 generates the name of the extraction model based on, for example, the attribute of the training data and the feature amount with high importance level. The relationship between the attribute and the feature amount with high importance level of the training data and the name of the extraction model is set as, for example, a table. For example, in a case where the season in which the product is sold is important in the similarity determination of the extraction model, “season” indicating the attribute and “season emphasis” indicating the name are associated in the table. In such a case, the name generation unit 17 generates the name of the extraction model as “season emphasis model”. The relationship between the change value of the set value and the name of the extraction model may be set as a table. For example, in a case where the importance level of the season in which the product is sold is changed in the similarity determination of the extraction model, “season” indicating the attribute and “season importance level change” indicating the name are associated in the table. In such a case, the name generation unit 17 generates the name of the extraction model as “season importance level change model”. The name generation unit 17 may generate the name of the extraction model by combining the names extracted from the table based on the attribute of the training data and the feature amount with high importance level. For example, in a case where the season in which the product is sold and the design are important in the similarity determination of the extraction model, “season” indicating the attribute, “season emphasis” indicating the name, “design” indicating the attribute, and “design emphasis” are associated in the table. In such a case, the name generation unit 17 generates the name of the extraction model as “season design emphasis model”. For example, the name generation unit 17 may generate the name of the extraction model by further combining the name extracted from the table with the name of the extraction model based on the change value of the set value.

The name generation unit 17 may generate the name of the extraction model using the name generation model. The name generation model is generated by deep learning using, for example, a neural network. The name generation model is generated, for example, by learning the relationship between the feature amount having a large influence on the similarity determination and the name of the extraction model. The name generation model may be generated by learning the relationship between the feature amount having a large influence on the type of the target product and the similarity determination and the name of the extraction model. The training data used for generating the name generation model is not limited to the above. The name generation model is generated, for example, in a system outside the extraction system 10. The name generation model may be generated by a learning means (not illustrated) in the extraction system 10.

FIG. 2 is a diagram illustrating an example of a screen displaying an extraction result of an item similar to a target product. In the example of the display screen of FIG. 2, three products similar to the target product are displayed. The output unit 13 outputs, for example, a screen shown in the example of the display screen of FIG. 2 based on the result extracted by the extraction unit 11 using the extraction model. In the example of the display screen of FIG. 2, an image of each product similar to the target product is displayed. In the example of the display screen of FIG. 2, data of “item name”, “brand”, “price”, “color”, and “release date” are displayed for each product similar to the target product. The “item name” is, for example, a name of an item. The “brand” is, for example, a name of a brand that sells the item. The “price” is a sales price of the item. The “color” is, for example, a basic color of the item. The “release date” is, for example, a month in which the item is released. The output unit 13 outputs, for example, a feature amount having a higher contribution degree to the similarity determination than other feature amounts among the feature amounts used by the extraction model in the similarity determination to a screen showing an extraction result. The screen shown in the example of the display screen of FIG. 2 is output. In the example of the display screen of FIG. 2, the similarity is displayed for each product similar to the target product. The output unit 13 outputs, for example, the similarity of each product to the target product in the similarity determination performed by the extraction model to a screen showing an extraction result. The screen shown in the example of the display screen of FIG. 2 is output. In the example of the display screen of FIG. 2, a button of “setting change” is displayed. The button of “setting change” is, for example, a button for displaying a screen for changing the set value of the importance level of the feature amount. The screen for changing the set value of the importance level of the feature amount is, for example, a screen for displaying the feature amount used by the extraction model for similarity determination, the set value of the importance level of the feature amount, and a change field for changing the set value of the importance level of the feature amount, and the output unit 13 outputs, for example, a “setting change” button illustrated in the example of the display screen of FIG. 2 to a screen showing an extraction result. When the button is pressed on the output screen, the acquisition unit 14 acquires information indicating that the button has been pressed. When the information indicating that the button has been pressed is acquired, the output unit 13 outputs a screen for changing the set value of the importance level of the feature amount.

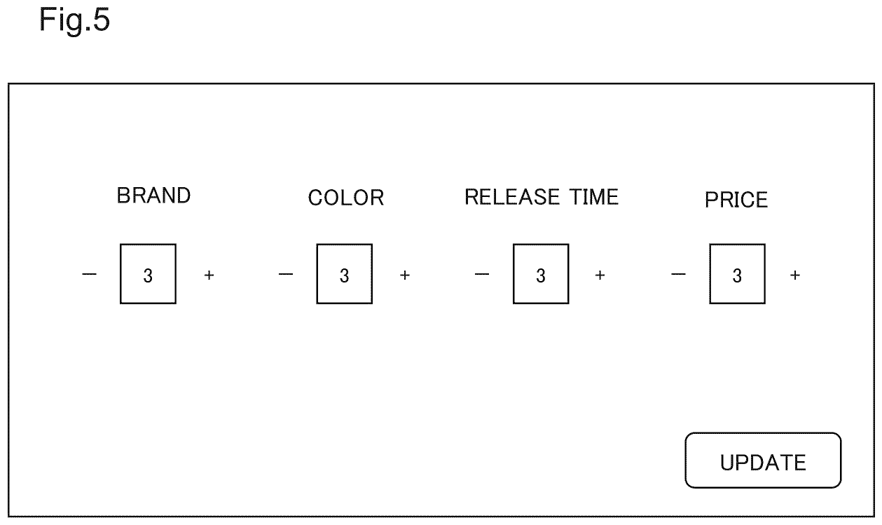

FIG. 5 is a diagram illustrating an example of a display screen for changing the set value of the importance level of the feature amount. In the example of the display screen of FIG. 5, “brand”, “color”, “release date”, and “price” are displayed as the feature amounts. In the example of the display screen of FIG. 5, the set value of the importance level is displayed for each of the feature amounts. In the example of the display screen of FIG. 5, “3” is displayed as the set value of the importance level of each feature amount. In the example of the display screen of FIG. 5, “+” and “−” buttons are displayed for each of the feature amounts. The “+” button is, for example, a button for increasing the set value of the feature amount by being clicked on the screen. The “−” button is, for example, a button for decreasing the set value of the feature amount by being clicked on the screen. The buttons “+” and “−” are an example of a change field for changing the set value of the importance level of the feature amount. In the example of the display screen of FIG. 5, an “update” button is displayed. The “update” button is a button for reflecting the set value of the importance level of the feature amount after the change in the extraction of the similar product by the extraction model.

The output unit 13 outputs, for example, a screen shown in the example of the display screen of FIG. 5. Then, when the change value is input to the change field and the “update” button is pressed on the output screen, the acquisition unit 14 acquires the change value for changing the set value of the importance level of the feature amount and information indicating that the button has been pressed. The update unit 15 updates the set value of the importance level of the feature amount in the extraction model based on the change value for changing the set value of the importance level of the feature amount, and for example, the acquired change value. When the “update” button is pressed, a product similar to the target product may be extracted by the extraction model in which the set value of the importance level of the feature amount has been changed. In this case, when the change value for changing the set value of the importance level of the feature amount and the information indicating that the button has been pressed are acquired, the update unit 15 updates the set value of the importance level of the feature amount in the extraction model based on, for example, the acquired change value. For example, the extraction unit 11 extracts a product similar to the target product based on the set value of the importance level of the feature amount after the update. When extraction of a product similar to the target product is executed by the extraction model using the set value of the importance level of the feature amount after the change, the output unit 13 outputs, for example, a screen displaying a newly executed extraction result, similarly to the example of the display screen of FIG. 2.

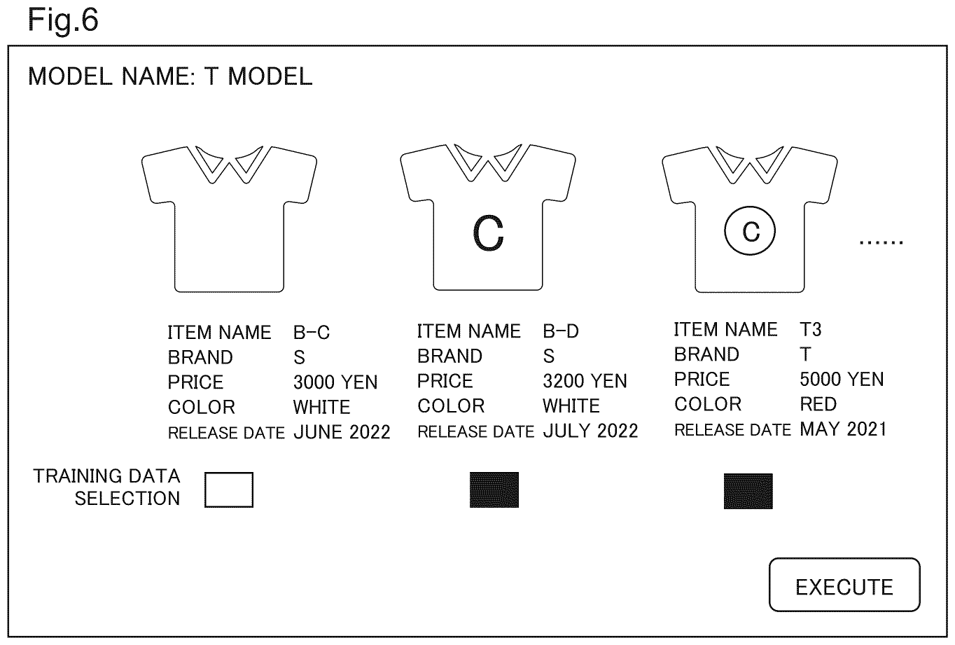

FIG. 6 is a diagram illustrating an example of a display screen for selecting training data to be used for generation of an extraction model or relearning of an extraction model. The training data selected in the example of the display screen of FIG. 6 may be used for generating the extraction model. In the example of the display screen of FIG. 6, the name of the extraction model is displayed as “T model”. In the example of the display screen of FIG. 6, an image of each product similar to the target product is displayed. In the example of the display screen of FIG. 6, data of “item name”, “brand”, “price”, “color”, and “release date” are displayed for each product similar to the target product. The output unit 13 outputs, for example, a screen for selecting a product to be used as training data in the generation of the extraction model or the relearning of the extraction model as illustrated in the example of the display screen of FIG. 6.

Furthermore, in the example of the display screen of FIG. 6, buttons for selecting an item to be used as training data are displayed for each item. In the example of the display screen of FIG. 6, for example, an item displayed in black is used as the training data by being clicked on the screen. In the example of the display screen of FIG. 6, when the button displayed in black is clicked, white is displayed and the selection is released. Furthermore, in the example of the display screen of FIG. 6, “execute” button is displayed. When the “execute” button is pressed, machine learning using the selected training data is executed. The machine learning using the selected training data may include relearning of the extraction model. When a product to be used as training data is selected on the screen output by the output unit 13, the acquisition unit 14 acquires a selection result of the product to be used as training data. When the “execute” button is pressed on the screen, the acquisition unit 14 acquires, for example, information indicating that the button has been pressed. When the information indicating that the “execute” button has been pressed is acquired, the model update unit 16 retrains the extraction model by using the product selected in the selection result as training data.

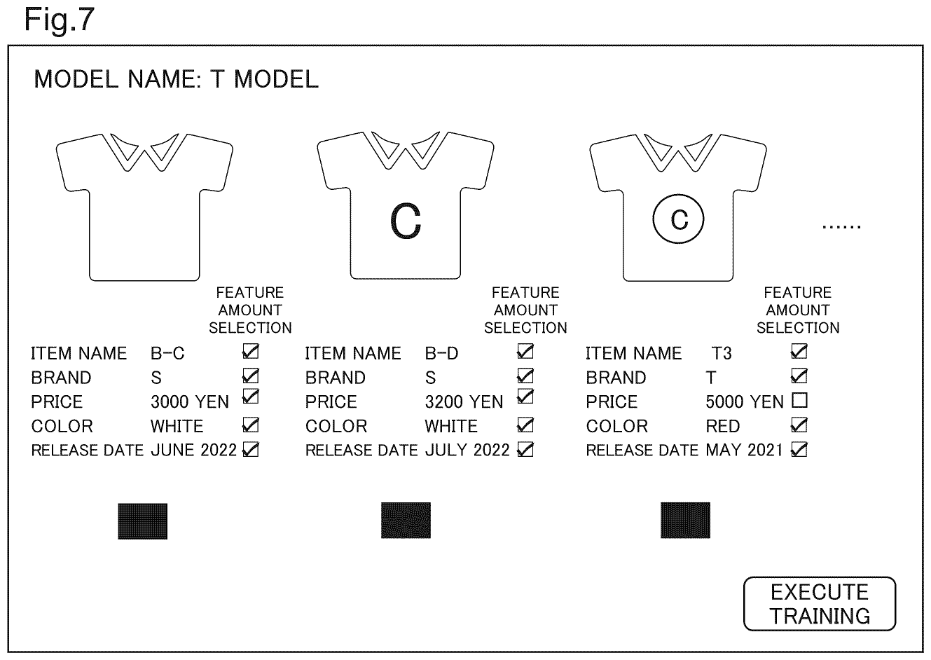

FIG. 7 is a diagram illustrating an example of a display screen on which a feature amount to be used for training data can be further selected on a display screen for selecting training data. In the example of the display screen of FIG. 7, in addition to the display content similar to that of the example of the display screen of FIG. 6, a check box for selecting a feature amount to be used for learning for each item is displayed as “feature amount selection”. The output unit 13 outputs, for example, a screen for selecting a feature amount to be used for training data as illustrated in the example of the display screen of FIG. 7. In the example of the display screen of FIG. 7, the feature amount in a state where the check box is checked is used for relearning. When the check box is checked and clicked, the selection is released. In the example of the display screen of FIG. 7, “execute” button is displayed. When the “execute” button is pressed, machine learning using the selected training data and feature amount is executed. The feature amount selected in the example of the display screen of FIG. 7 may be used for generating the extraction model. When the “execute” button is pressed in a state where the feature amount is selected on the screen output by the output unit 13, the acquisition unit 14 acquires, for example, a selection result of the feature amount to be used as the training data and information indicating that the “execute” button has been pressed. When the selection result of the feature amount to be used as the training data and the information indicating that the “execute” button has been pressed are acquired, the model update unit 16 retrains the extraction model using the feature amount selected in the selection result as the training data.

The terminal device 20 is, for example, a terminal device used by the user to operate the extraction system 10. For example, the terminal device 20 acquires, from the output unit 13 of the extraction system 10, a screen displaying the feature amount used by the extraction model for similarity determination, the set value of the importance level of the feature amount, and the change field for changing the set value of the importance level of the feature amount. Then, the terminal device 20 displays the acquired screen on a display device (not illustrated).

The terminal device 20 acquires, for example, a change value of the importance level of the feature amount input by a user's operation on a screen output to the display device. The screen output from the terminal device 20 to the display device is a screen acquired by the terminal device 20 from the output unit 13 of the extraction system 10. Then, the terminal device 20 outputs the change value of the importance level of the feature amount to the acquisition unit 14 of the extraction system 10.

The terminal device 20 outputs, for example, a screen for selecting training data to be used for generation of the extraction model or relearning of the extraction model from the output unit 13 of the extraction system 10. Then, the terminal device 20 displays the screen acquired from the output unit 13 of the extraction system 10 on a display device (not illustrated). The image data of the screen may be generated in the terminal device 20. In a case where the image data of the screen is generated in the terminal device 20, the terminal device 20 acquires an instruction of the display content from the output unit 13 of the extraction system 10.

The terminal device 20 acquires, for example, a selection result of the training data to be used for generation of the extraction model or relearning of the extraction model input by the user's operation on a screen displayed on the display device. The input may include an operation selected by the user from among the candidates displayed on the screen. Then, the terminal device 20 outputs a selection result of the training data to be used for generation of the extraction model or relearning of the extraction model to the acquisition unit 14 of the extraction system 10.

As the terminal device 20, for example, a personal computer, a tablet computer, or a smartphone can be used. In addition, the terminal device 20 may be a system integrated with the extraction system 10.

The data management device 30 saves the name of the product and the attribute data of the product. The data management device 30 may further save an image obtained by photographing the product. A plurality of data management devices 30 may be provided. When there is a plurality of data management devices 30, the names of the products related to different industry types and the attribute data of the products may be saved for each data management device 30.

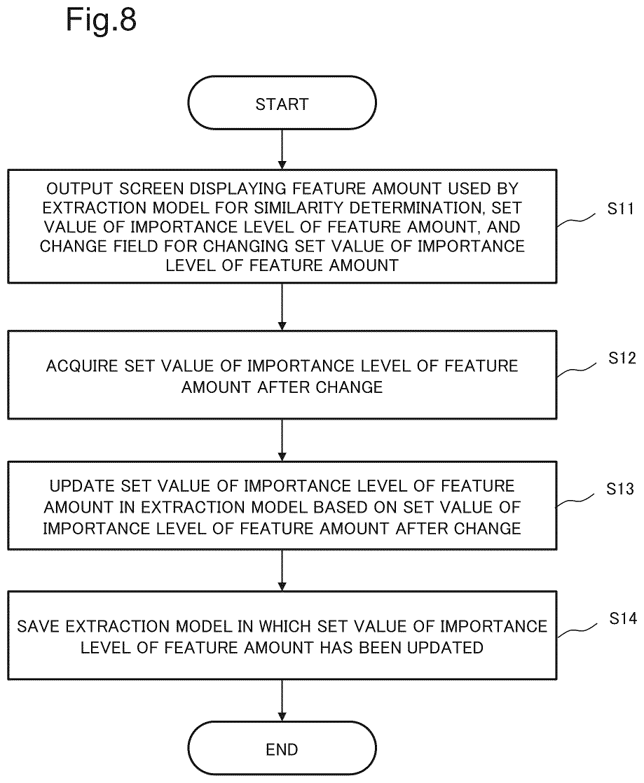

The process of changing the set value of the importance level of the feature amount in the extraction model in the extraction system 10 will be described. FIG. 8 is a diagram illustrating an example of an operation flow in the process of changing the set value of the importance level of the feature amount.

The output unit 13 outputs a screen displaying the feature amount used by the extraction model for similarity determination, the set value of the importance level of the feature amount, and the change field for changing the set value of the importance level of the feature amount (step S11). The extraction model is a learning model for extracting a product similar to the target product. For example, the output unit 13 outputs, to the terminal device 20, a screen displaying the feature amount used for similarity determination by the extraction model that extracts a product similar to the target product, the set value of the importance level of the feature amount, and the change field for changing the set value of the importance level of the feature amount.

For example, the terminal device 20 displays, on a display device (not illustrated), a screen displaying a feature amount used for similarity determination by an extraction model that extracts a product similar to a target product, a set value of an importance level of the feature amount, and a change field for changing the set value of the importance level of the feature amount.

When the user operates the terminal device 20 on the screen displayed on the display device to input the change value for changing the set value of the importance level of the feature amount, the terminal device 20 outputs the input change value to the extraction system 10.

The acquisition unit 14 of the extraction system 10 acquires, for example, a change value for changing the set value of the importance level of the feature amount (step S12). The extraction system 10 acquires, for example, a change value for changing the set value of the importance level of the feature amount output from the terminal device 20.

When the change value for changing the set value of the importance level of the feature amount is acquired, the update unit 15 updates the set value of the importance level of the feature amount in the extraction model based on the change value for changing the set value of the importance level of the feature amount acquired by the acquisition unit 14 (step S13).

When the set value of the importance level of the feature amount in the extraction model is updated, the update unit 15 saves, for example, the updated extraction model (step S14). The update unit 15 saves the updated extraction model in, for example, the storage unit 12.

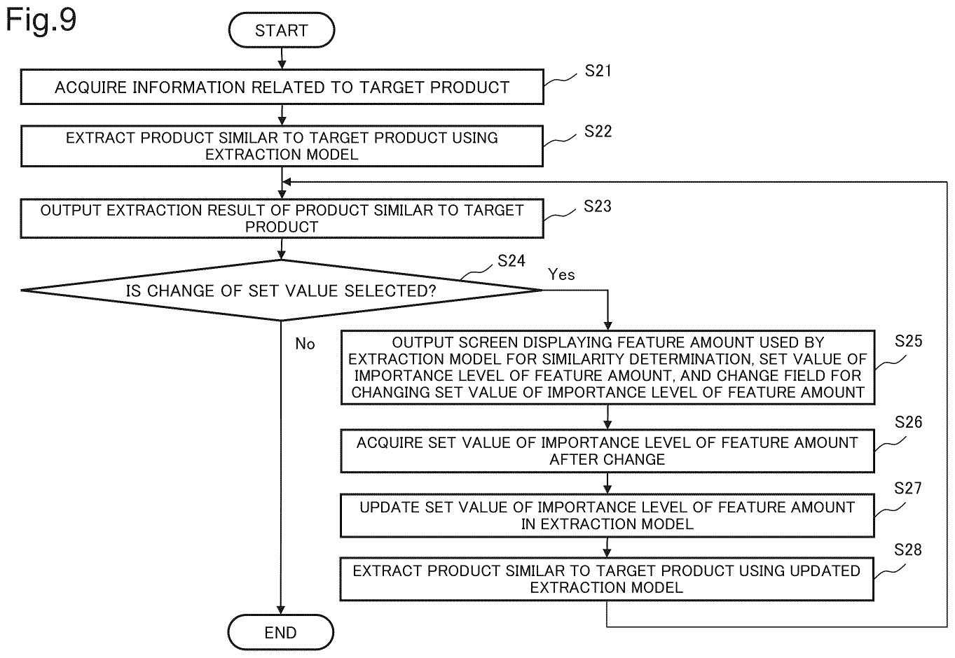

The process of extracting a product similar to the target product in the extraction system 10 will be described. FIG. 9 is a diagram illustrating an example of an operation flow in a process of extracting a product similar to the target product.

The acquisition unit 14 acquires, for example, information on the target product (step S21). The acquisition unit 14 acquires, for example, attribute data of a target product as information on the target product.

When the information on the target product is acquired, the extraction unit 11 extracts a product similar to the target product using, for example, the extraction model (step S22). For example, the extraction unit 11 extracts a product similar to the target product using the extraction model based on the information on the target product.

When a product similar to the target product is extracted, the output unit 13 outputs, for example, a screen displaying an extraction result of the product similar to the target product (step 23). For example, the output unit 13 outputs a screen displaying a button for selecting to perform an operation of changing the set value of the importance level of the feature amount together with the extraction result. The output unit 13 outputs, for example, a screen displaying an extraction result of a product similar to the target product to the terminal device 20. The terminal device 20 displays, for example, a screen displaying an extraction result of a product similar to the target product on a display device (not illustrated).

In a case where the button for changing the set value of the importance level of the feature amount is pressed by the operation of the user on the output screen and it is selected to change the set value of the importance level of the feature amount (Yes in step S24), the output unit 13 outputs a screen displaying the feature amount used for similarity determination by the extraction model, the set value of the importance level of the feature amount, and the change field for changing the set value of the importance level of the feature amount (step S25). For example, the output unit 13 outputs, to the terminal device 20, a screen displaying the feature amount used for similarity determination by the extraction model that extracts a product similar to the target product, the set value of the importance level of the feature amount, and the change field for changing the set value of the importance level of the feature amount.

For example, the terminal device 20 outputs, on a display device (not illustrated), a screen displaying a feature amount used for similarity determination by an extraction model that extracts a product similar to a target product, a set value of an importance level of the feature amount, and a change field for changing the set value of the importance level of the feature amount.

When the importance level of the feature amount is changed by the user operating the terminal device 20, the terminal device 20 outputs a set value of the importance level of the feature amount after the change to the extraction system 10.

The extraction system 10 acquires, for example, a set value of the importance level of the feature amount after the change from the terminal device 20 (step S26).

When the set value of the importance level of the feature amount after the change is acquired, the update unit 15 updates the set value of the importance level of the feature amount in the extraction model based on the set value of the importance level of the feature amount after the change acquired by the acquisition unit 14 (step S27).

When the set value of the importance level of the feature amount is updated, the extraction unit 11 extracts a product similar to the target product using, for example, the extraction model with the updated set value (step S28).

When a product similar to the target product is extracted, the process returns to step S23, and the output unit 13 outputs, for example, an extraction result of a product similar to the target product.

In step S24, in a case where it is not selected to change the set value of the importance level of the feature amount (No in step S24), the extraction system 10 waits, for example, until the next new operation is performed. For example, a button of “OK” or “end” may be displayed on the screen displaying the extraction result, and when the button is pressed on the screen, the extraction system 10 may end the process of extracting a product similar to the target product.

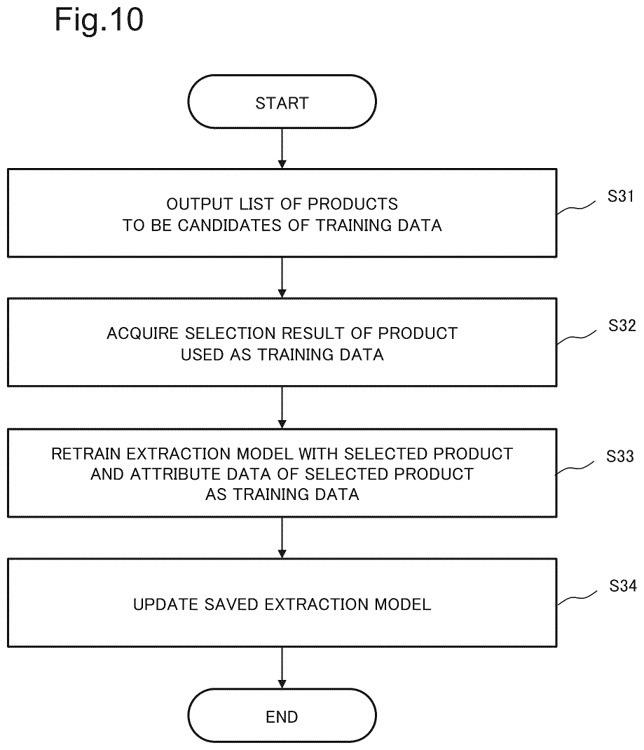

The process of updating the extraction model by relearning in the extraction system 10 will be described. FIG. 10 is a diagram illustrating an example of an operation flow in the process of updating the extraction model by relearning.

The output unit 13 outputs, for example, a list of products that are candidates for training data (step S31). The output unit 13 outputs, for example, a list of products that are candidates for training data to the terminal device 20.

The terminal device 20 outputs a list of products that are candidates for training data to, for example, a display device (not illustrated). The terminal device 20 acquires selection of a product to be used as training data input by the operation of a user. The terminal device 20 outputs, for example, selection of a product to be used as training data to the extraction system 10.

The acquisition unit 14 acquires selection of a product to be used as training data (step S32).

When the selection of the product to be used as the training data is acquired, the model update unit 16 retrains the extraction model using the selected product and the attribute data of the selected product as the training data (step S33).

When the relearning of the extraction model is performed, for example, the model update unit 16 updates the extraction model saved in the storage unit 12 by the retrained extraction model (step S34).

The extraction system 10 is applicable to, for example, the medical healthcare field. For example, the extraction system 10 can be used to extract a product similar to a health food before the release used for demand prediction of a health food before the release. For example, a person planning a new product of a health food can estimate the demand for the health food to be released based on a product similar to the health food before the release. In this way, it is possible to support decision-making for planning a new product of a health food by extracting a product similar to a new product of a health food. In addition, the extraction system 10 can be used, for example, to extract a drug similar to a new drug. Furthermore, the extraction system 10 may extract a person instead of the product. For example, upon a doctor deciding a medical treatment policy, the extraction system 10 extracts a patient whose treatment history and attribute are similar to those of a patient to be treated. Then, the doctor can determine a medical treatment policy with reference to, for example, information on a patient whose medical history and attributes are similar to those of a patient to be treated. In addition, a nurse and a physical therapist may extract data of patients having similar treatment histories and attributes using the extraction system 10, and determine a response policy for the patient. In this way, by using the extraction system 10, for example, it is possible to support decision-making by medical personnel.

The extraction system 10 outputs a screen displaying a feature amount used for similarity determination by an extraction model that extracts a product similar to a target product, a set value of an importance level of the feature amount, and a change field for changing the set value of the importance level of the feature amount. he extraction system 10 acquires the change value of the importance level of the feature amount input on the screen. Then, the extraction system 10 updates the set value of the importance level of the feature amount in the extraction model based on the change value. In this way, for example, the user can easily adjust the extraction result of the product similar to the target product by updating the set value of the importance level of the feature amount in the extraction model based on of the change value of the importance level of the feature amount input on the screen. Therefore, the extraction of a product similar to the target product can be facilitated by using the extraction system 10.

For example, the extraction system 10 further outputs a screen displaying an extraction result obtained by extracting a product similar to the target product using the extraction model after updating the set value of the importance level of the feature amount. The user can grasp how the extraction result has changed by, for example, changing the set value of the importance level of the feature amount by displaying the extraction result obtained by extracting a product similar to the target product using the updated extraction model. Therefore, a product similar to the target product can be more appropriately extracted.

In addition, the extraction system 10 outputs, for example, a screen on which a product to be used for relearning the extraction model can be selected on the screen. The user can easily select training data to be used for relearning of the extraction model by outputting a screen on which a product to be used for relearning of the extraction model can be selected on the screen. Therefore, a product more suitable for the application of the user can be extracted as a product similar to the target product by using the extraction system 10.

In addition, the extraction system 10 outputs, for example, a screen on which a feature amount to be used for relearning the extraction model can be selected on the screen. The user can easily select the feature amount to be used for relearning of the extraction model by outputting a screen on which the feature amount to be used for relearning of the extraction model can be selected on the screen. Therefore, a product more suitable for the application of the user can be extracted as a product similar to the target product by using the extraction system 10.

In a case where an extraction model that can explain the reason for the extraction result is used, the extraction system 10 outputs, for example, a screen that displays the reason for the extraction result together with the extraction result. The user can easily understand the extraction result by outputting the reason together with the extraction result. In addition, by outputting the reason together with the extraction result, the user can more appropriately select the feature to be changed and determine the change value when changing the importance level of the feature amount.

The extraction system 10 generates the name of the extraction model based on, for example, the attribute of the training data and the feature amount with high importance level. Therefore, when selecting an extraction model to be used for extraction from a plurality of extraction models, the user can easily select an extraction model suitable for the type or application of the target product based on the name. Therefore, extraction of a product suitable for the application of the user can be facilitated by using the extraction system 10.

Each process in the extraction system 10 may be executed in a distributed manner in a plurality of information processing systems connected via a network. For example, the process in the output unit 13, the acquisition unit 14, the update unit 15, and the extraction unit 11 and the process in the model update unit 16 may be performed in another information processing system. For example, the process in the output unit 13, the acquisition unit 14, the update unit 15, the extraction unit 11 and the model update unit 16 and the process in the model update unit 16 may be performed in another information processing system. Which one of the plurality of information processing systems to perform each process in the extraction system 10 can be appropriately set. Some or all of the processes in the extraction system 10 may be performed in the terminal device 20.

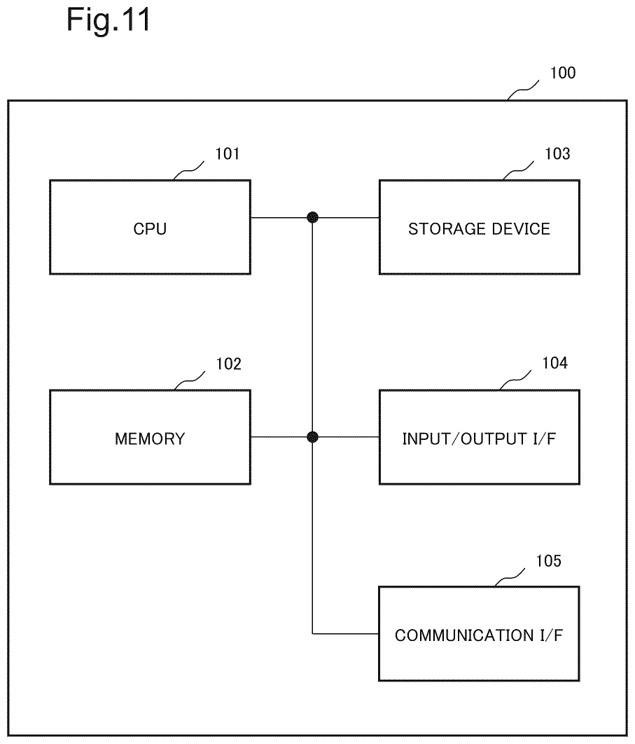

Each process in the extraction system 10 can be achieved by executing a computer program on a computer. FIG. 11 illustrates an example of a configuration of a computer 100 that executes a computer program for performing each process in the extraction system 10. The computer 100 includes a central processing unit (CPU) 101, a memory 102, a storage device 103, an input/output interface (I/F) 104, and a communication I/F 105.

The CPU 101 reads and executes a computer program for performing each process from the storage device 103. The CPU 101 may be configured by a combination of a plurality of CPUs. The CPU 101 may be configured by a combination of a CPU and another type of processor. For example, the CPU 101 may be configured by a combination of a CPU and a graphics processing unit (GPU). The memory 102 includes a dynamic random access memory (DRAM) or the like, and temporarily stores a computer program to be executed by the CPU 101 and data being processed. The storage device 103 stores a computer program to be executed by the CPU 101. The storage device 103 includes, for example, a nonvolatile semiconductor storage device. As the storage device 103, another storage device such as a hard disk drive may be used. The input/output I/F 104 is an interface that receives an input from an operator and outputs display data and the like. The communication I/F 105 is an interface that transmits and receives data between the terminal device 20 and the data management device 30. The terminal device 20 and the data management device 30 can have a similar configuration.

The computer program used for executing each process can also be distributed by being stored in a computer-readable recording medium that non-transiently records data. As the recording medium, for example, a magnetic tape for data recording or a magnetic disk such as a hard disk can be used. As the recording medium, an optical disk such as a compact disc read only memory (CD-ROM) can also be used. A nonvolatile semiconductor storage device may be used as a recording medium.

At the planning stage of a new product, for example, demand prediction of the new product is performed. The demand prediction of the new product is performed using, for example, sales result data of a product similar to the new product among the products launched in the market. A product similar to the new product is selected by, for example, a person who performs demand prediction of the new product. However, for example, with the technology described in the background art, it may be difficult to extract a similar product suitable for prediction.

Therefore, in order to solve the above problems, an object of the present disclosure is to provide an extraction system and the like that can facilitate extraction of a product similar to a target product.

By using the extraction system or the like of the present disclosure, for example, extraction of a product similar to the target product can be facilitated.

Some or all of the above example embodiments may be described as the following supplementary notes, but are not limited to the following.

### [Supplementary Note 1]

An extraction system comprising:
an output unit for outputting a screen displaying a feature amount used for similarity determination by an extraction model that extracts a product similar to a target product, a set value of an importance level of the feature amount, and a change field for changing the set value of the importance level of the feature amount;
an acquisition unit for acquiring a change value for changing the set value of the importance level of the feature amount input to the change field of the output screen; and
an update unit for updating a set value of an importance level of the feature amount in the extraction model based on the change value.

### [Supplementary Note 2]

The extraction system according to supplementary note 1, further comprising
an extraction unit for extracting a product similar to the target product using the extraction model; wherein
the output unit outputs, together with a result of the extraction, a feature amount used by the extraction model for the similarity determination, a set value of an importance level of the feature amount, and a change field for changing the set value.

### [Supplementary Note 3]

The extraction system according to supplementary note 2, wherein
the extraction unit re-extracts a product similar to the target product using the extraction model, based on the set value of the importance level after the updating.

### [Supplementary Note 4]

The extraction system according to supplementary note 2 or 3, wherein
the output unit outputs a screen for selecting a product to be used as training data from the products extracted by the extraction model,
the acquisition unit acquires a selection result of a product to be used as training data, the product being selected on the output screen, and
a model update unit for updating the extraction model by executing machine learning using a product selected in the selection result as training data is further provided.

### [Supplementary Note 5]

The extraction system according to supplementary note 2 or 3, wherein
the output unit outputs a screen for selecting a feature amount also to be used as training data from feature amounts used for training of the extraction model,
the acquisition unit acquires a selection result of a feature amount to be used as the training data, the feature amount being selected on the output screen, and
a model update unit for updating the extraction model by executing machine learning using a feature amount selected in the selection result as training data is further provided.

### [Supplementary Note 6]

The extraction system according to supplementary note 2 or 3, wherein
when outputting a screen displaying a product extracted by the extraction model, the output unit outputs a screen that further displays a feature amount that has contributed to similarity determination on similarity with the target product.

### [Supplementary Note 7]

The extraction system according to supplementary note 1, wherein
the output unit outputs a screen for selecting any extraction model among a plurality of extraction models,
the acquisition unit acquires a selection result of an extraction model selected on the output screen, and
the output unit outputs a screen displaying a feature amount in the extraction model selected in the selection result, a set value of an importance level of the feature amount, and a change field for changing the set value of the importance level of the feature amount.

### [Supplementary Note 8]

The extraction system according to supplementary note 1, further comprising
a name generation unit for generating a name of the extraction model, based on at least one of a feature amount used as training data of the extraction model and an importance level of the feature amount.

### [Supplementary Note 9]

The extraction system according to supplementary note 1, wherein
the output unit outputs a screen including a button for switching between a screen for displaying a product extracted by the extraction model and a screen for displaying a change field for changing the set value of the importance level of the feature amount in the extraction model.

### [Supplementary Note 10]

The extraction system according to supplementary note 6, wherein
the output unit outputs a screen that displays a feature amount that has contributed to the similarity determination by the extraction model in descending order of contribution to the similarity determination.

### [Supplementary Note 11]

The extraction system according to supplementary note 1, wherein
the output unit outputs a button for increasing or decreasing a set value by an operation on a screen as a change field for changing the set value of the importance level of the feature amount.

### [Supplementary Note 12]

The extraction system according to supplementary note 1, wherein
the output unit further outputs a standard feature amount and an importance level of the feature amount in an industry in which the target product is distributed.

### [Supplementary Note 13]

An extraction method comprising:
outputting a screen displaying a feature amount used for similarity determination by an extraction model that extracts a product similar to a target product, a set value of an importance level of the feature amount, and a change field for changing the set value of the importance level of the feature amount;
acquiring a change value for changing the set value of the importance level of the feature amount input to the change field of the output screen; and
updating a set value of an importance level of the feature amount in the extraction model based on the change value.

### [Supplementary Note 14]

The extraction method according to supplementary note 13, further comprising:
extracting a product similar to the target product using the extraction model; and
outputting, together with a result of the extraction, a feature amount used by the extraction model for the similarity determination, a set value of an importance level of the feature amount, and a change field for changing the set value.

### [Supplementary Note 15]

The extraction method according to supplementary note 14, further comprising
re-extracting a product similar to the target product using the extraction model, based on the set value of the importance level after the updating.

### [Supplementary Note 16]

The extraction method according to supplementary note 14 or 15, further comprising:
outputting a screen for selecting a product to be used as training data from the products extracted by the extraction model;
acquiring a selection result of a product to be used as training data selected on the output screen; and
updating the extraction model by executing machine learning using a product selected in the selection result as training data.

### [Supplementary Note 17]

The extraction method according to supplementary note 14 or 15, further comprising:
outputting a screen for selecting a feature amount to be used also as training data from feature amounts used for training of the extraction model;
acquiring a selection result of a feature amount to be used as the training data selected on the output screen; and
updating the extraction model by executing machine learning using a feature amount selected in the selection result as training data.

### [Supplementary Note 18]

The extraction method according to supplementary note 14 or 15, further comprising
outputting a screen that further displays a feature amount that has contributed to similarity determination on similarity with the target product when outputting a screen displaying a product extracted by the extraction model.

### [Supplementary Note 19]

The extraction method according to supplementary note 13, further comprising:
outputting a screen for selecting any extraction model among a plurality of extraction models;
acquiring a selection result of an extraction model selected on the output screen; and
outputting a screen displaying a feature amount in the extraction model selected in the selection result, a set value of an importance level of the feature amount, and a change field for changing the set value of the importance level of the feature amount.

### [Supplementary Note 20]

The extraction method according to supplementary note 13, further comprising
generating a name of the extraction model, based on at least one of a feature amount used as training data of the extraction model and an importance level of the feature amount.

### [Supplementary Note 21]

The extraction method according to supplementary note 13, further comprising
outputting a screen including a button for switching between a screen for displaying a product extracted by the extraction model and a screen for displaying a change field for changing the set value of the importance level of the feature amount in the extraction model.

### [Supplementary Note 22]

The extraction method according to supplementary note 18, further comprising
outputting a screen that displays a feature amount that has contributed to the similarity determination by the extraction model in descending order of contribution to the similarity determination.

### [Supplementary Note 23]

The extraction method according to supplementary note 13, further comprising
outputting a button for increasing or decreasing a set value by an operation on a screen as a change field for changing the set value of the importance level of the feature amount.

### [Supplementary Note 24]

The extraction method according to supplementary note 13, further comprising
outputting a standard feature amount and an importance level of the feature amount in an industry in which the target product is distributed.

### [Supplementary Note 25]

A non-transiently recording medium that records an extraction program for causing a computer to execute:
a process of outputting a screen displaying a feature amount used for similarity determination by an extraction model that extracts a product similar to a target product, a set value of an importance level of the feature amount, and a change field for changing the set value of the importance level of the feature amount;
a process of acquiring a change value for changing the set value of the importance level of the feature amount input to the change field of the output screen; and
a process of updating a set value of an importance level of the feature amount in the extraction model based on the change value.

### [Supplementary Note 26]

The non-transiently recording medium according to supplementary note 25, wherein the extraction program further causing the computer to execute:
a process of extracting a product similar to the target product using the extraction model; and
a process of outputting, together with a result of the extraction, a feature amount used by the extraction model for the similarity determination, a set value of an importance level of the feature amount, and a change field for changing the set value.

### [Supplementary Note 27]

The non-transiently recording medium according to supplementary note 26, in which the extraction program further causing the computer to execute:
a process of re-extracting a product similar to the target product using the extraction model, based on a set value of the importance level after the updating.

### [Supplementary Note 28]

The non-transiently recording medium according to supplementary note 26 or 27, in which the extraction program further causing the computer to execute:
a process of outputting a screen for selecting a product to be used as training data from the products extracted by the extraction model;
a process of acquiring a selection result of a product to be used as training data selected on the output screen; and
a process of updating the extraction model by executing machine learning using a product selected in the selection result as training data.

### [Supplementary Note 29]

The non-transiently recording medium according to supplementary note 26 or 27, in which the extraction program further causing the computer to execute:
a process of outputting a screen for selecting a feature amount to be used also as training data from feature amounts used for training of the extraction model;
a process of acquiring a selection result of a feature amount to be used as the training data selected on the output screen; and
a process of updating the extraction model by executing machine learning using a feature amount selected in the selection result as training data.

### [Supplementary Note 30]

The non-transiently recording medium according to supplementary note 26 or 27, in which the execution program further causing the computer to execute:
a process of, when outputting a screen displaying a product extracted by the extraction model, outputting a screen that further displays a feature amount that has contributed to similarity determination on similarity with the target product.

### [Supplementary Note 31]

The non-transiently recording medium according to supplementary note 25, in which the execution program further causing the computer to execute:
a process of outputting a screen for selecting any extraction model from a plurality of extraction models;
a process of acquiring a selection result of an extraction model selected on the output screen; and
a process of outputting a screen displaying a feature amount in the extraction model selected in the selection result, a set value of an importance level of the feature amount, and a change field for changing the set value of the importance level of the feature amount.

### [Supplementary Note 32]

The non-transiently recording medium according to supplementary note 25, in which the execution program further causing the computer to execute:
a process of generating a name of the extraction model, based on at least one of a feature amount used as training data of the extraction model and an importance level of the feature amount.

### [Supplementary Note 33]

The non-transiently recording medium according to supplementary note 25, in which the execution program further causing the computer to execute:
a process of outputting a screen including a button for switching between a screen for displaying a product extracted by the extraction model and a screen for displaying a change field for changing the set value of the importance level of the feature amount in the extraction model.

### [Supplementary Note 34]

The non-transiently recording medium according to supplementary note 30, in which the execution program further causing the computer to execute:
a process of outputting a screen that displays a feature amount that has contributed to the similarity determination by the extraction model in descending order of contribution to the similarity determination.

### [Supplementary Note 35]

The non-transiently recording medium according to supplementary note 25, in which the execution program further causing the computer to execute:
a process of outputting an image for increasing or decreasing a set value by operation on a screen as a change field for changing the set value of the importance level of the feature amount.

### [Supplementary Note 36]

The non-transiently recording medium according to supplementary note 25, in which the execution program further causing the computer to execute:
a process of further outputting a standard feature amount and an importance level of the feature amount in an industry in which the target product is distributed.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An extraction system comprising:
at least one memory storing instructions; and
at least one processor configured to access the at least one memory and execute the instructions to:
output a screen displaying a feature amount used for similarity determination by an extraction model that extracts a product similar to a target product, a set value of an importance level of the feature amount, and a change field for changing the set value of the importance level of the feature amount;
acquire a change value for changing the set value of the importance level of the feature amount input to the change field of the output screen; and
update a set value of an importance level of the feature amount in the extraction model based on the change value.

2. The extraction system according to claim 1, wherein
the at least one processor is further configured to execute the instructions to:
extract a product similar to the target product using the extraction model; and
output, together with a result of the extraction, a feature amount used by the extraction model for the similarity determination, a set value of an importance level of the feature amount, and a change field for changing the set value.

3. The extraction system according to claim 2, wherein
the at least one processor is further configured to execute the instructions to:
re-extract a product similar to the target product using the extraction model, based on the set value of the importance level of the feature amount after the updating.

4. The extraction system according to claim 2, wherein
the at least one processor is further configured to execute the instructions to:
output a screen for selecting a product to be used as training data from the products extracted by the extraction model;
acquire a selection result of a product to be used as training data, the product being selected on the output screen; and
update the extraction model by executing machine learning using a product selected in the selection result as training data.

5. The extraction system according to claim 2, wherein
the at least one processor is further configured to execute the instructions to:
output a screen for selecting a feature amount to be used also as training data from feature amounts used for training of the extraction model,
acquire a selection result of a feature amount to be used as the training data, the feature amount being selected on the output screen, and
update the extraction model by executing machine learning using a feature amount selected in the selection result as training data is further provided.

6. The extraction system according to claim 2, wherein
the at least one processor is further configured to execute the instructions to:
output a screen that further displays a feature amount that has contributed to similarity determination on similarity with the target product, when outputting a screen displaying a product extracted by the extraction model.

7. The extraction system according to claim 1, wherein
the at least one processor is further configured to execute the instructions to:
output a screen for selecting any extraction model among a plurality of extraction models;
acquire a selection result of an extraction model selected on the output screen; and
output a screen displaying a feature amount in the extraction model selected in the selection result, a set value of an importance level of the feature amount, and a change field for changing the set value of the importance level of the feature amount.

8. The extraction system according to claim 1, wherein
the at least one processor is further configured to execute the instructions to:
generate a name of the extraction model, based on at least one of a feature amount used as training data of the extraction model and an importance level of the feature amount.

9. The extraction system according to claim 1, wherein
the at least one processor is further configured to execute the instructions to:
output a screen including a button for switching between a screen for displaying a product extracted by the extraction model and a screen for displaying a change field for changing the set value of the importance level of the feature amount in the extraction model.

10. The extraction system according to claim 6, wherein
the at least one processor is further configured to execute the instructions to:
output a screen that displays a feature amount that has contributed to the similarity determination by the extraction model in descending order of contribution to the similarity determination.

11. The extraction system according to claim 1, wherein
the at least one processor is further configured to execute the instructions to:
output a button for increasing or decreasing a set value by an operation on a screen as a change field for changing the set value of the importance level of the feature amount.

12. The extraction system according to claim 1, wherein
the at least one processor is further configured to execute the instructions to:
output a standard feature amount and an importance level of the feature amount in an industry in which the target product is distributed.

13. An extraction method comprising:
outputting a screen displaying a feature amount used for similarity determination by an extraction model that extracts a product similar to a target product, a set value of an importance level of the feature amount, and a change field for changing the set value of the importance level of the feature amount;
acquiring a change value for changing the set value of the importance level of the feature amount input to the change field of the output screen; and
updating a set value of an importance level of the feature amount in the extraction model based on the change value.

14. The extraction method according to claim 13, further comprising:
extracting a product similar to the target product using the extraction model; and
outputting, together with a result of the extraction, a feature amount used by the extraction model for the similarity determination, a set value of an importance level of the feature amount, and a change field for changing the set value.

15. The extraction method according to claim 14, further comprising
re-extracting a product similar to the target product using the extraction model, based on the set value of the importance level after the updating.

16. The extraction method according to claim 14, further comprising:
outputting a screen for selecting a product to be used as training data from the products extracted by the extraction model;
acquiring a selection result of a product to be used as training data selected on the output screen; and
updating the extraction model by executing machine learning using a product selected in the selection result as training data.

17. The extraction method according to claim 14, further comprising:
outputting a screen for selecting a feature amount to be used also as training data from feature amounts used for training of the extraction model;
acquiring a selection result of a feature amount to be used as the training data selected on the output screen; and
updating the extraction model by executing machine learning using a feature amount selected in the selection result as training data.

18. The extraction method according to claim 14, further comprising
outputting a screen that further displays a feature amount that has contributed to similarity determination on similarity with the target product when outputting a screen displaying a product extracted by the extraction model.

19. The extraction method according to claim 13, further comprising:
outputting a screen for selecting any extraction model among a plurality of extraction models;
acquiring a selection result of an extraction model selected on the output screen; and
outputting a screen displaying a feature amount in the extraction model selected in the selection result, a set value of an importance level of the feature amount, and a change field for changing the set value of the importance level of the feature amount.

20. A non-transiently recording medium that records an extraction program for causing a computer to execute:
a process of outputting a screen displaying a feature amount used for similarity determination by an extraction model that extracts a product similar to a target product, a set value of an importance level of the feature amount, and a change field for changing the set value of the importance level of the feature amount;
a process of acquiring a change value for changing the set value of the importance level of the feature amount input to the change field of the output screen; and
a process of updating a set value of an importance level of the feature amount in the extraction model based on the change value.
